(19) United States
(12) Patent Application Publication
(10) Pub. No.: US 2010/0089135 A1
(43) Pub. Date: Apr. 15, 2010

(54) DEVICE AND METHOD FOR MEASURING SENSOR CHIPS

(75) Inventors: Michel de Langen, Beuningen (NL); Evelyne Gridelet, Seraing (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/249,483

(22) Filed: Oct. 10, 2008

(51) Int. Cl. G01N 15/06

(52) U.S. Cl. 73/61.71

(57) ABSTRACT

A device and method for measuring a sensor chip with bond pads uses a plurality of conductive elements configured to be sufficiently rigid to penetrate oxidation on the bond pads to electrically connect to the bond pads of the sensor chip to exchange measurement information with the sensor chip.

Silicon sensor and biosensor chips have been developed for detection of specific molecules or biomolecules, such as Deoxyribonucleic acid (DNA) or proteins, which is of great interest in the field of medical diagnostics.

A biosensor may be denoted as a device which may be used for the detection of an analyte and may combine a biological component with a physicochemical or physical detector component. For instance, a biosensor may be based on the phenomenon that capture particles immobilized on a surface of a sensor, may selectively attach with target particles in a fluidic sample, for instance when an antibody-binding fragment of an antibody or the sequence of a DNA single strand as a capture particle fits to a corresponding sequence or structure of a target particle. When such attachment or sensor events occur at the sensor surface, this may change the electrical properties of the surface which can be detected as the sensor event.

Sensor chips are typically packaged as disposable cartridges, which are inserted into sensor measurement devices to extract information from the sensor chips. A conventional sensor measurement device includes components to support a sensor cartridge with a sensor chip, to supply a fluid to the sensor chip and to electrically connect to the sensor chip to exchange information with the sensor chip.

One of the concerns with the conventional sensor package is that this packaging consists of disposable cartridges that are relatively expensive to manufacture. One of the concerns with the conventional sensor measurement devices is that these devices are not easily modifiable with respect to different components, which provide different functionalities for the measurement devices.

In view of the above concerns, there is a need for a sensor measurement device, which uses cost effective sensor packaging, that is designed to be easily modifiable.

A device and method for measuring a sensor chip with bond pads uses a plurality of conductive elements configured to be sufficiently rigid to penetrate oxidation on the bond pads to electrically connect to the bond pads of the sensor chip to exchange measurement information with the sensor chip. The device may use a modular design so that different components of the device can be made separately, which can be assembled together by the user of the device.

A device for measuring a sensor chip with bond pads in accordance with an embodiment of the invention comprises a support module configured to support a sensor unit having the sensor chip, a microfluidic module being configured to be placed on the support module and further configured to contact the sensor unit to supply a fluid containing particles, which may be biological particles, onto the sensor chip of the sensor unit, and an electric system module configured to be placed on the support module, the electric system module including a substrate and a plurality of conductive elements connected to the substrate, the conductive elements being configured to be sufficiently rigid to penetrate oxidation on the bond pads to electrically connect to the bond pads of the sensor chip to exchange measurement information with the sensor chip, the measurement information being related to detection of the particles on the sensor chip. In some embodiments, the support module, the microfluidic module and the electric system module are modular in design.

A method for measuring a sensor chip with bond pads in accordance with an embodiment of the invention comprises providing a sensor unit having the sensor chip, a support module, an electric system module and a microfluidic module of a sensor measurement device, placing the sensor unit, the electric system module and the microfluidic module on the support module to form an assembled sensor measurement device, including positioning the sensor chip on the support module such that the microfluidic module contacts the sensor unit to supply a fluid containing particles onto the sensor chip and the electric system module is electrically connected to the bond pads of the sensor chip via conductive elements of the electric system module that are configured to be sufficiently rigid to penetrate oxidation on the bond pads to electrically connect to the bond pads, supplying the fluid containing the particles onto the sensor chip of the sensor chip through the microfluidic module, and receiving measurement information from the sensor unit through the electric system module via the conductive elements of the electric system that are electrically connected to the bond pads of the sensor chip, the measurement information being related to detection of the particles on the sensor chip.

Other aspects and advantages of the present invention will become apparent from the following detailed description, taken in conjunction with the accompanying drawings, illustrated by way of example of the principles of the invention.

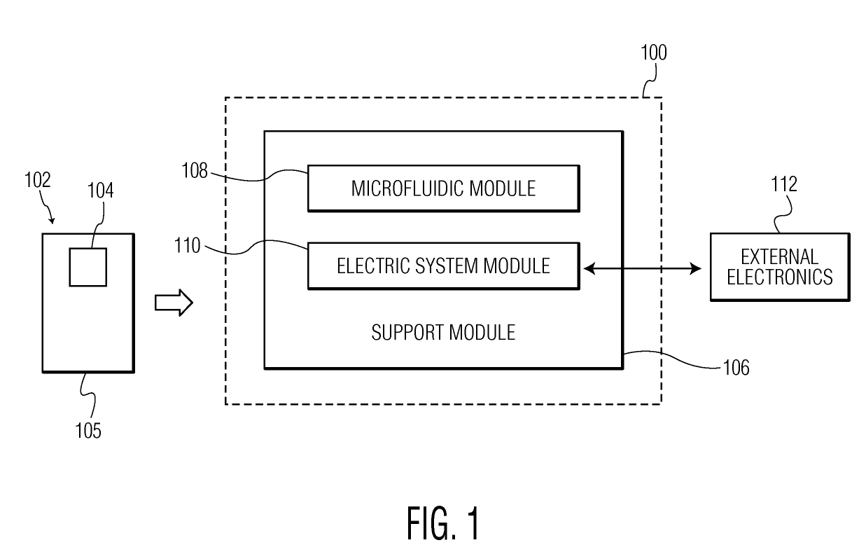

FIG. 1 is a block diagram of a sensor measurement device in accordance with an embodiment of the invention.

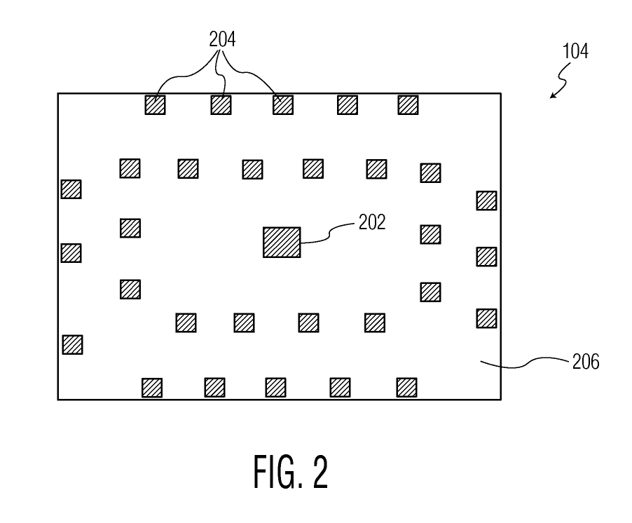

FIG. 2 is a top view of a sensor chip of a sensor unit used in the sensor measurement device of FIG. 1 in accordance with an embodiment of the invention.

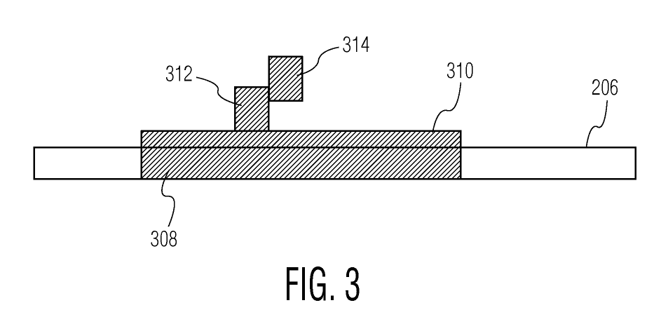

FIG. 3 is a cross-sectional view of the sensor chip of FIG. 2.

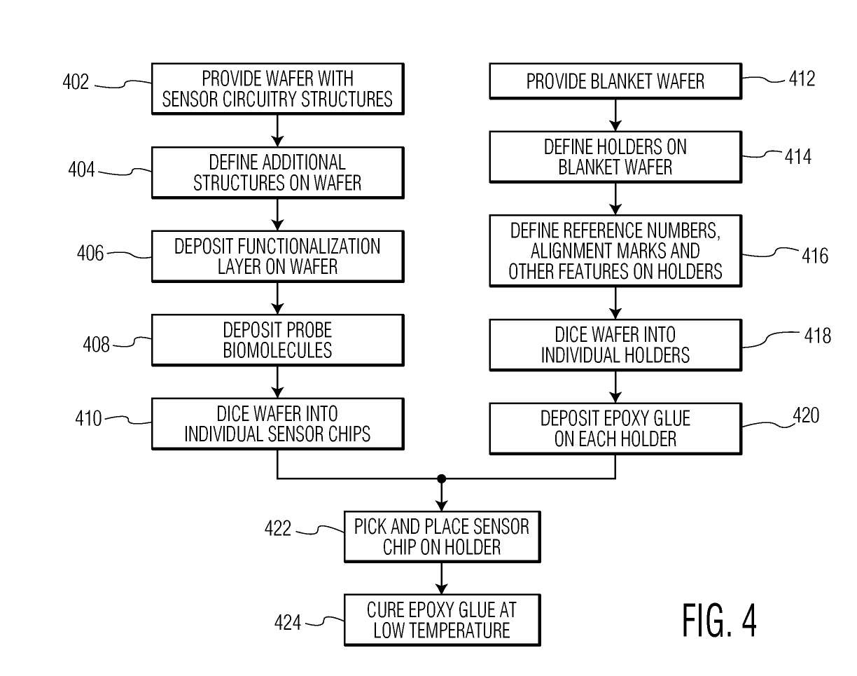

FIG. 4 is a flow diagram of a process of producing sensor units in accordance with an embodiment of the invention.

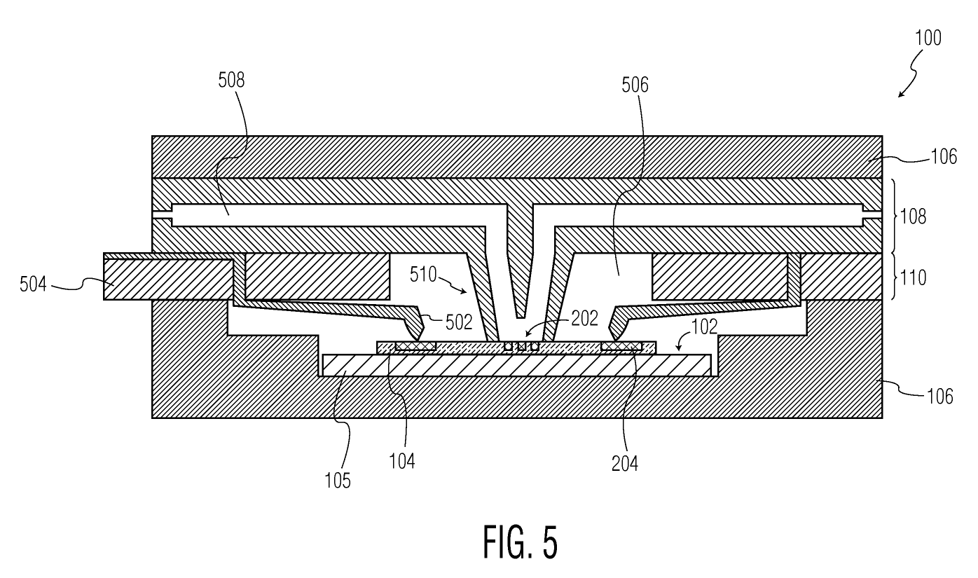

FIG. 5 is a diagram of the sensor measurement device in accordance with an embodiment of the invention.

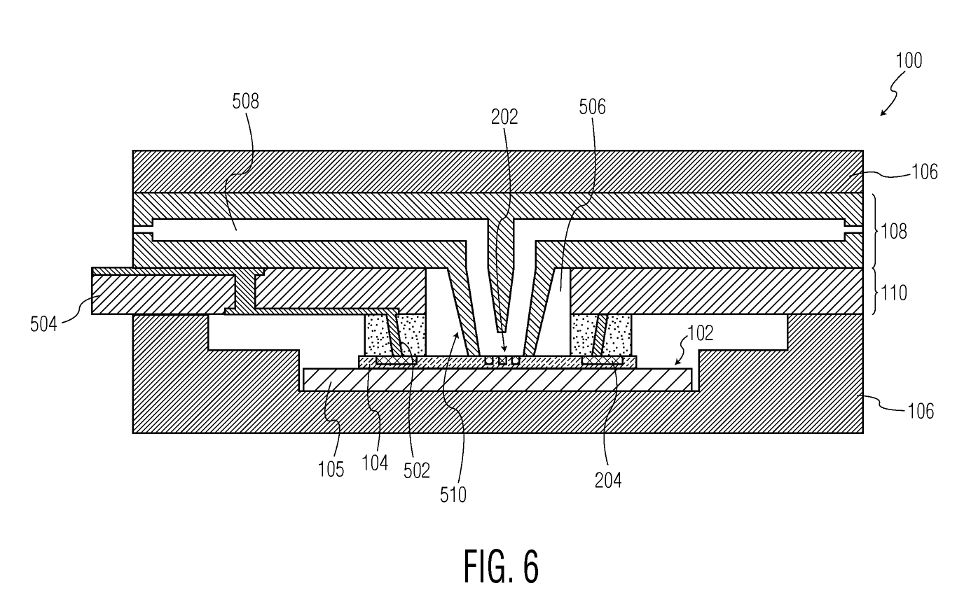

FIG. 6 is a diagram of the sensor measurement device in accordance with an alternative embodiment of the invention.

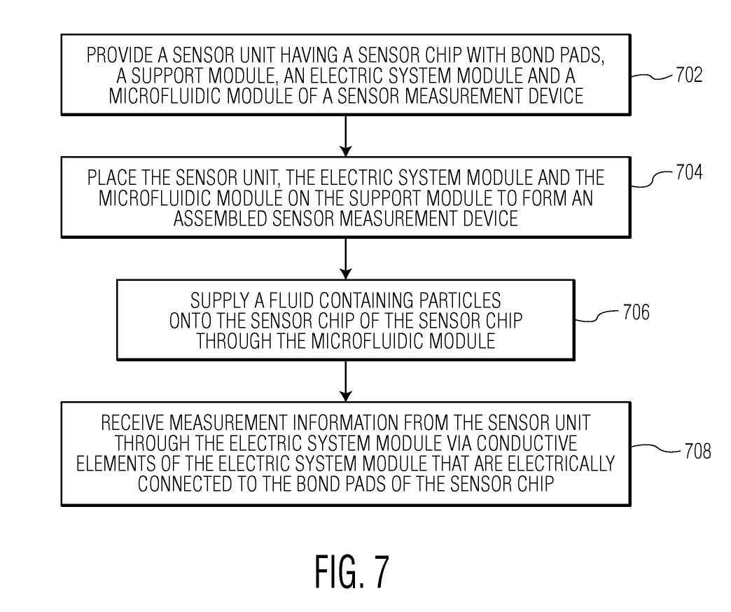

FIG. 7 is a process flow diagram of a method for measuring a sensor chip with bond pads in accordance with an embodiment of the invention.

Unless stated otherwise, the following definitions shall apply throughout the specification and claims.

The term “sensor” may particularly denote any device which may be used for the detection of an analyte. Examples of sensors which may be realized according to exemplary embodiments are gas sensors, smoke sensors, sensors, pH sensors, humidity sensors, etc.

The term “sensor” may also particularly denote any device which may be used for the detection of a component of an analyte comprising biological particles such as DNA, Ribonucleic acid (RNA), proteins, enzymes, cells, bacteria, virus, etc. A sensor may combine a biological component (for instance capture particles at a sensor active surface capable of detecting particles) with a physicochemical or physical detector component (for instance a capacitor having an electric characteristic which is modifiable by a sensor event).

The term “sensor chip” may particularly denote that a sensor built with the help of micro- or nano-technologies like lithography, etch or deposition techniques. It may particularly denote an integrated circuit (IC), i.e., an electronic chip, particularly in semiconductor technology, more particularly in silicon semiconductor technology, still more particularly in complementary metal oxide semiconductor (CMOS) technology. A monolithically integrated sensor chip has the property of having very small dimensions due to the use of micro- or nano-processing technology, and may therefore have a large spatial resolution and a high signal-to-noise ratio particularly when the dimensions of the sensor chip or more precisely of components thereof approach or reach the order of magnitude of micrometers or less, for instance, a sensor reaching the dimensions of biological particles.

The term “fluidic” may particularly denote any subset of the phases of matter. Such fluids may include liquids, gases, plasmas and, to some extent, solids, as well as mixtures thereof. Examples for fluidic samples are DNA containing fluids, cells containing fluids, blood, interstitial fluid in subcutaneous tissue, muscle or brain tissue, urine or other body fluids. For instance, a fluidic sample may be a biological substance. Such a substance may comprise proteins, polypeptides, nucleic acids, DNA strands, etc.

The term “particle” may particularly denote a molecule, an organic molecule, a biological particle, DNA, RNA, a protein, an amino acid, a bead, a nano-bead, a nano-tube, etc.

The term “biological particles” may particularly denote any particles which play a significant role in biology or in biological or biochemical procedures, such as genes, DNA, RNA, proteins, enzymes, cells, bacteria, virus, etc.

With reference to FIG. 1, a sensor measurement device 100 in accordance with an embodiment of the invention is described. The sensor measurement device 100 uses a sensor unit 102 having a silicon sensor chip 104 on a holder 105 to detect particles, which may be biological particles. In this embodiment, the sensor chip 104 is designed to detect biomolecules, such as a DNA strand for example, which is of special interest to medical diagnostics. As described below, the sensor unit 102 is designed to be cost effective to reduce the cost of operation of the sensor measurement device.

As illustrated in FIG. 1, the sensor measurement device 100 includes a support module 106, a microfluidic module 108 and an electric system module 110 to measure the silicon sensor chip 104 on the sensor unit 102, which is inserted into the device to make a measurement. The support module 106 is configured to provide support for the sensor unit 102 inserted into the sensor measurement device 100. The support module 106 is also configured to provide structural support for the other components of the sensor measurement device, i.e., the microfluidic module 108 and the electric system module 110. The microfluidic module 108 and the electric system 110 module are configured to be placed on the support module 106 so that the sensor measurement device 100 can be assembled by the user of the device. The sensor measurement device 100 uses a modular design, which allows components of the device to be made separately and assembled together by the user just prior to use. The modular design of the sensor measurement device 100 makes it easier to replace contaminated components of the device or to replace existing components of the device with improved or modified components, even the sensor unit 102.

The microfluidic module 110 is configured to deliver a fluid containing a biological sample, which may include biomolecules to be detected, onto the sensor unit 102 when the unit is inserted into the device 100. The electric system module 110 is configured to electrically contact the sensor chip 104 of the sensor unit 102 to exchange detection information with the sensor chip in the form of electrical signals. The electric system module 110 is connected to external electronics 112, which receives and processes the electrical signals from the sensor unit 102 via the electric system module to make the measurement. The external electronics 112 may also control various components of the sensor measurement device 100, such as the microfluidic module 108 and the electric system module 110. The sensor unit 102, the support module 106, the microfluidic module 108 and the electric system module 110 are described in more detail below. The sensor measurement device 100 may include other components, which are not shown or described herein to not obscure the inventive features of the sensor measurement device.

Turning now to FIGS. 2 and 3, the silicon sensor chip 104 of the sensor unit 102 is shown. FIG. 2 is a top view of the sensor chip 104, while FIG. 3 is a cross-sectional view of the sensor chip. As shown in FIG. 2, the sensor chip 104 includes a detection area 202 and a number of bond pads 204, which are electrically isolated from each other by dielectric material 206. The detection area 202 is where a fluid containing a biological sample is applied to the sensor chip 104 and allowed to flow to detect any biomolecules contained therein. The detection area 202 is formed of an array of nanoelectrodes 308, which is indicated in FIG. 3. As an example, the size of the detection area 202 may be 150 μm by 185 μm. The nanoelectrodes 308 are coated with a functionalization layer 310, typically a self-assembled monolayer, which is deposited in an organic solvent, as shown in FIG. 3. The specificity of the sensor chip 104 is obtained by attaching known probe biomolecules 312, such as a complementary DNA strand of a target DNA strand for example, to the functionalization layer 310 that can specifically attach to target biomolecules 314, the target DNA strand for example, as illustrated in FIG. 3. A measurement of the sensor chip 104 results in the detection of the attachment of the target biomolecule to the probe biomolecule. In some embodiments, several types of known probe biomolecules may be deposited on the functionalization layer 310 to detect several different types of target biomolecules in the detection area 202 of the sensor chip 104. The deposition of one or more types of probe biomolecules may be performed by the user of the sensor measurement device 100 prior to inserting the sensor unit 102 in the measurement device a measurement.

The nanoelectrodes 308 of the sensor chip 104 are electrically connected to some on-chip circuitry (not shown) that is connected to the bond pads 204, which are used to provide electrical connections to the sensor measurement device 100 to exchange measurement information related to the detection area 202 of the sensor chip or related to the on-chip circuitry of the sensor chip. In an embodiment, the bond pads 204 are made of copper because copper is the standard material of IC technology. However, the use of copper may prevent good electrical contacts between the bond pads 204 of the sensor chip 104 and the electric system module 110 of the sensor measurement device 100 due to oxide formed on the copper bond pads. This issue is addressed by the design of the electric system module 110, as described below.

A process of producing sensor units, such as the sensor unit 102, in accordance with an embodiment of the invention is described with reference to a flow diagram of FIG. 4. Blocks 402-410 illustrate the sub-process of producing sensor chips of the sensor units. Blocks 412-418 illustrate the sub-process of producing holders of the sensor units.

The sub-process of producing the sensor chips begins at block 402, where a silicon wafer with sensor circuitry structures, including nanoelectrodes that define detection areas and bond pads, is provided. In an embodiment, the sensor circuitry structures are formed using CMOS technology. Next, at optional block 404, additional structures such as SU8 structures may be defined or formed on the wafer. Next, at block 406, a functionalization layer is deposited on the wafer, which may preferentially attach to exposed copper structures on the wafer, rather than to the dielectric material on the wafer. Next, at block 408, probe biomolecules are deposited on the functionalization layer on detection areas by spotting, printing or other suitable technique such that, for example, a single biomolecule is attached to each of the one hundred (100) to one thousand (1,000) nanoelectrodes. In some embodiments, up to one hundred (100) kinds of different biomolecules are deposited on each detection array of nanoelectrodes, i.e., each detection area. Next, at block 410, the wafer is diced into separate individual sensor chips by using a blade, a laser or any other suitable means for cutting a wafer into chips. The employed dicing technique may be adapted in order to not damage the functionalization layer and the probe biomolecules on the wafer. In an embodiment, the surface of the wafer may be ground before the wafer is diced.

The sub-process of producing the holders of the sensor units begins at block 412, where a blanket wafer made of glass, silicon, etc. or any suitable piece of material is provided. Next, at block 414, the holders are defined on the blanket wafer using lithographic and etch techniques. In an embodiment, the holders may be defined as an asymmetric shape to help with the alignment when each resulting sensor unit is inserted into the support module 106 of the sensor measurement device 100. The size of the holders is selected so that the sensor units can be easily handled by hand or with a tweezer and placed on the support module. As an example, the size of the sensor chips may be 2×2 mm² and the size of the holders may be 10×20 mm². Next, at block 416, reference numbers, alignment marks and other features may be defined on the holders by lithographic, deposition and etch techniques. Additional features such as fiducials may also be defined on the holders to assist in accurate placement of the sensor chips on the holders or the holders in the support module 106 of the sensor measurement device 100. Next, at block 418, the wafer is diced into separate individual holders. In an embodiment, the surface of the wafer may be ground before the wafer is diced.

The process of producing the sensor chip then proceeds to block 420, where epoxy glue, or other suitable glue is deposited at the location on each holder where the sensor chip will be placed. The glue should be chemically resistant, inert and curable at low temperature. Next, at block 422, a particular sensor chip is picked and placed on one of the holders by a pick and place machine, which involves some alignment of the sensor chip on the holder. In an embodiment, the sensor chip is placed asymmetrically, i.e., not at the center of the holder, as illustrated in FIG. 1, to help with the alignment when the resulting sensor unit is inserted into the support module 106 of the sensor measurement device 100. Next, the epoxy glue is cured at low temperature so that the functionalization layer and the biomolecules are not damaged. The curing may be performed by ultraviolet (UV) curing from backside of the holder. The resulting product is a sensor unit that may be used in the sensor measurement device 100.

In other embodiments, the deposition of the functionalization layer and/or the probe biomolecules may be performed at different times than prior to assembly of the sensor chip to the holder. In a first alternative embodiment, the depositions of the functionalization layer and the probe biomolecules are performed after the assembly of the sensor chip and the holder and the curing of the epoxy glue but before the sensor measurement device 100 is assembled. In this embodiment, the materials of the holder and the epoxy glue have to be carefully chosen to withstand the deposition of the functionalization layer and the probe biomolecules. In a second alternative embodiment, the functionalization layer is deposited during the sub-process of producing the sensor chips but the probe biomolecules are deposited after the assembly of the sensor chip and the holder and the curing of the epoxy glue but before the sensor measurement device 100 is assembled. In a third alternative embodiment, the functionalization layer and the probe biomolecules are deposited after the sensor measurement device 100 is assembled.

The support module 106, the microfluidic module 108 and the electric module 100 of the sensor measurement device 100 are further described with reference to FIG. 5. As shown in FIG. 5, the support module 106 is configured to mechanically support the sensor unit 102, the microfluidic module 108 and the electric system module 110, and serves as a housing for the sensor measurement device 100. The support module 106 is further configured to properly align the different components together. In an embodiment, the support module 106 may include alignment screws or other alignment system (not shown) to properly align the sensor unit 102 relative to the electric system module 110 and the microfluidic module 108. The support module 106 may be configured to provide a mechanical protection during the measurement against, for example, light and temperature changes. The support module 106 may include a temperature regulation element (not shown), such as a Pelletier element or a heat sink.

The electric system module 110 includes an electrical contactor 502 and a substrate 504. The electrical contactor 502 includes conductive elements, such as needles or wires, that are sufficiently rigid to scratch or penetrate into the oxidation covering the bond pads 204 of the sensor chip 104 of the sensor unit 102. The shape of the tip of these conductive elements can be tuned or configured to improve the scratching. In an embodiment, the electrical contactor 502 includes a plurality of probe elements commonly found in a fixed probe card, as illustrated in FIG. 5. In another embodiment, the electrical contact 502 is a plurality of probe wires commonly found in a buckling beam probe, as illustrated in FIG. 6. The substrate 504 is configured to provide electrical connections between the contactor 502 and the external electronics 112 connected to the sensor measurement device 100. The substrate 504 may be a printed circuit board, a flex foil, a conductive board, or an assembly of several parts used for fixed probe cards and buckling beam systems. The substrate 504 includes a hole 506 that is used by the microfluidic module 108, as described below. In an embodiment, the hole 506 is located in the substrate 504 such that the hole is positioned over the detection area 202 of the sensor chip 104 of the sensor unit 102. One or more sides of the substrate 504 may extend outside the support module 106 of the sensor measurement device 100 to allow mounting of an electrical connector or other electrical connection to the external electronics 112.

The microfluidic module 108 can be a plastic part containing one or more channels 508 that deliver a fluid containing a biological sample, which may include biomolecules to be detected, onto the surface of the sensor chip 104 of the sensor unit 102 at the detection area 202 of the sensor chip. The microfluidic module 106 includes a nozzle-like portion 510 that touches or contacts the sensor chip 104 to deliver the fluid onto the detection area 202 so that the biomolecules in the fluid, if any, are attached to the probe biomolecules attached to the functionalization layer on the detection area of the sensor chip. The microfluidic module 108 is positioned relative to the substrate 504 of the electric system module 110 such that the nozzle-like portion 510 of the microfluidic module extends through the hole 506 of the substrate to touch the sensor chip 104 of the sensor unit 102. The sealing of the contact between the microfluidic module and the sensor chip can be insured by glue, a rubber piece, pressure or other means. When a fluid flows through the microfluidic module 108 onto the sensor chip 104 of the sensor unit 102, the pressure caused by the fluid will tend to push the sensor chip away from the microfluidic module, which may be prevented by some features of the support module 106 to press the sensor chip and the microfluidic module together. In some embodiments, the microfluidic module 108 can also contain additional microfluidic components (not shown), such as mixers, reaction chambers and sieves, and may also include additional components, such as a conductive counter electrode. At one or more sides of the microfluidic module 108, connections are made to allow the fluid to enter or exit the microfluidic module. In an embodiment, the microfluidic module 108 is a disposable component and is designed to merely press against the substrate 504 of the electric system module 110. In other embodiments, the microfluidic module 108 may be designed to be reusable. In these embodiments, the microfluidic module 108 may be glued to the substrate 504 of the electric system module 110 or to the sensor chip 104 of the sensor unit 102.

In an embodiment, the process of assembling the sensor measurement device 100 includes placing the sensor unit 102 on the support module 106. Next, the electric system module 110 is placed on the support module 106 so that the conductive elements 502 are electrically connected to the bond pads 204 of the sensor chip 104 of the sensor unit 102. Next, the microfluidic module 108 is placed on the support module 106 over the electric system module 110 so that the nozzle-like portion 510 is positioned in the hole 506 of the substrate 504 of the electric system module and is placed on the sensor chip 104 of the sensor unit 102. The sensor measurement device 100 can now be used to make a measurement.

A method for measuring a sensor chip with bond pads in accordance with an embodiment of the invention is described with reference to a process flow diagram of FIG. 7. At block 702, a sensor unit having the sensor chip, a support module, an electric system module and a microfluidic module of a sensor measurement device are provided. Next, at block 704, the sensor unit, the electric system module and the microfluidic module are placed on the support module to form an assembled sensor measurement device, including positioning the sensor chip on the support module such that the microfluidic module contacts the sensor unit to supply a fluid containing particles, which may be biological particles, onto the sensor chip and the electric system module is electrically connected to the bond pads of the sensor chip via conductive elements of the electric system module that are configured to be sufficiently rigid to penetrate oxidation on the bond pads to electrically connect to the bond pads of the sensor chip. Next, at block 706, the fluid containing the particles is supplied onto the sensor chip of the sensor chip through the microfluidic module. Next, at block 706, measurement information from the sensor unit is received through the electric system module via the conductive elements of the electric system that are electrically connected to the bond pads of the sensor chip. The measurement information includes information related to detection of the particles on the sensor chip of the sensor unit.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device for measuring a sensor chip with bond pads comprising:
a support module configured to support a sensor unit having the sensor chip;
a microfluidic module being configured to be placed on the support module, the microfluidic module being further configured to contact the sensor unit to supply a fluid containing particles onto the sensor chip of the sensor unit; and
an electric system module configured to be placed on the support module, the electric system module including a substrate and a plurality of conductive elements connected to the substrate, the conductive elements being configured to be sufficiently rigid to penetrate oxidation on the bond pads to electrically connect to the bond pads of the sensor chip to exchange measurement information with the sensor chip, the measurement information being related to detection of the particles on the sensor chip.

2. The device of claim 1 wherein the support module, the microfluidic module and the electric system module are modular in design so that the support module, the microfluidic module and the electric system module can be manufactured independently and assembled by a user of the device.

3. The device of claim 1 wherein the bond pads of the sensor chip are copper bond pads.

4. The device of claim 1 wherein the conductive elements of the electric system module are probe elements that are commonly found in a fixed probe card.

5. The device of claim 1 wherein the conductive elements of the electric system module are probe wires that are commonly found in a buckling beam probe.

6. The device of claim 1 wherein the electric system module is positioned between the microfluidic module and the sensor unit when the device is assembled.

7. The device of claim 6 wherein the substrate of the electric system module includes a hole and the microfluidic module includes a nozzle-like portion, the nozzle-like portion of the microfluidic module being positioned in the hole of the substrate of the electric system module when the device is assembled.

8. The device of claim 1 wherein the substrate of the electric system module is a printed circuit board, a flex foil or a conductive board.

9. The device of claim 1 wherein the sensor unit includes a functionalization layer and probe particles.

10. The device of claim 1 wherein the contact between the microfluidic module and the sensor unit is sealed for fluids.

11. A method for measuring a sensor chip with bond pads, the method comprising:
providing a sensor unit having the sensor chip, a support module, an electric system module and a microfluidic module of a sensor measurement device;
placing the sensor unit, the electric system module and the microfluidic module on the support module to form an assembled sensor measurement device, including positioning the sensor chip on the support module such that the microfluidic module contacts the sensor unit to supply a fluid containing particles onto the sensor chip and the electric system module is electrically connected to the bond pads of the sensor chip via conductive elements of the electric system module that are configured to be sufficiently rigid to penetrate oxidation on the bond pads to electrically connect to the bond pads;
supplying the fluid containing the particles onto the sensor chip of the sensor chip through the microfluidic module; and
receiving measurement information from the sensor unit through the electric system module via the conductive elements of the electric system that are electrically connected to the bond pads of the sensor chip, the measurement information being related to detection of the particles on the sensor chip.

12. The method of claim 10 wherein the placing includes positioning the electric system module between the microfluidic module and the sensor unit.

13. The method of claim 11 wherein the placing further includes positioning a nozzle-like portion of the microfluidic module in a hole of a substrate of the electric system module, the substrate being connected to the conductive elements.

14. The method of claim 10 further comprising depositing a functionalization layer and probe particles on the sensor chip.

15. The method of claim 13 wherein the depositing of the functionalization layer on the sensor chip is performed before the sensor chip is attached to a holder of the sensor unit, after the sensor chip is attached to the holder of the sensor unit but before the sensor measurement device is assembled or after the sensor measurement device is assembled.

16. The method of claim 13 wherein the depositing of the probe particles on the sensor chip is performed before the sensor chip is attached to a holder of the sensor unit, after the sensor chip is attached to the holder of the sensor unit but before the sensor measurement device is assembled or after the sensor measurement device is assembled.

17. The method of claim 10 wherein the bond pads of the sensor chip are copper bond pads.

18. The method of claim 10 wherein the conductive elements of the electric system module are probe elements that are commonly found in a fixed probe card or probe wires that are commonly found in a buckling beam probe.

19. A device for measuring a sensor chip with bond pads comprising:
a support module configured to support a sensor unit having the sensor chip;
a microfluidic module being configured to be placed on the support module, the microfluidic module being further configured to contact the sensor unit to supply a fluid containing biological particles onto the sensor chip of the sensor unit; and
an electric system module configured to be placed on the support module, the electric system module including a substrate and a plurality of conductive elements connected to the substrate, the conductive elements being configured to be sufficiently rigid to penetrate oxidation on the bond pads to electrically connect to the bond pads of the sensor chip to exchange measurement information with the sensor chip, the measurement information being related to detection of the biological particles on the sensor chip,
wherein the support module, the microfluidic module and the electric system module are modular in design.

20. The device of claim 19 wherein the conductive elements of the electric system module are probe elements that are commonly found in a fixed probe card or probe wires that are commonly found in a buckling beam probe.
